(19) United States
(12) Patent Application Publication
(10) Pub. No.: US 2014/0293345 A1
(43) Pub. Date: Oct. 2, 2014

(54) NON-TRANSITORY COMPUTER-READABLE STORAGE MEDIUM AND LOCALIZATION METHOD FOR PRINTER DRIVER

(71) Applicant: KONICA MINOLTA, INC., Tokyo (JP)

(72) Inventor: Yoshiyuki Harada, Tokyo (JP)

(73) Assignee: KONICA MINOLTA, INC., Tokyo (JP)

(21) Appl. No.: 14/227,177

(22) Filed: Mar. 27, 2014

(30) Foreign Application Priority Data
Mar. 29, 2013 (JP) 2013-072109

(51) Int. Cl. G06F 3/12

(52) U.S. Cl. CPC G06F 3/1204; G06F 3/1255; G06F 3/1256
USPC 358/1.15

(57) ABSTRACT

Provided is a non-transitory computer-readable storage medium storing a printer driver and a localization method for the printer driver. The printer driver causes a computing device to perform the following processing. The processing includes creating print capability information based on a localization resource file including definitions of strings about print features and on a configuration file including a definition of a dummy feature wherein one of the strings is designated. The created print capability information includes descriptions of setup items of the print features and descriptions of option values of each setup item, and the designated string. The processing further includes, on handling a conflict in the print capability information, adding a description of a feature which is not allowed to be defined in the configuration file into the print capability information and reflecting the designated string on the description of the added feature; and creating a print setup screen based on the print capability information.

This application is based on Japanese Patent Application No. 2013-072109 filed on Mar. 29, 2013, in the Japan Patent Office, the entire content of which is hereby incorporated by reference.

### TECHNICAL FIELD

The present invention relates to a non-transitory computer-readable storage medium storing a printer driver therein and a localization method for the printer driver. In particular, the present invention relates to a non-transitory computer-readable storage medium storing a version 4 printer driver which is able to runs on Windows operating systems (WINDOWS is a registered trademark of Microsoft Corporation in the United States and other countries, and the same shall apply hereinafter) and a localization method for the printer driver.

### BACKGROUND

With regard to printer drivers which are able to run on Windows operating systems, Microsoft corporation (MICROSOFT is a registered trademark of Microsoft Corporation in the United States and other countries, and the same shall apply hereinafter) provides guidelines for hardware manufacturers. According to the guidelines, hardware manufacturers have provided version 3 printer drivers on the assumption the printer drivers work with Windows operation systems from Windows 2000 to Windows 7.

As the succeeding operating systems, there arrived Windows 8 and Windows Server 2012. Especially, since Windows 8 employs a metro-style user interface, which is a new and tile-like user interface, hardware manufacturers are developing version 4 printer drivers which employ a new printer driver architecture for those operation systems (for example, please see “Developing v4 Printer Drivers”, Sep. 28, 2012, Microsoft Corporation, retrieved from the Internet, “URL: http://msdn.microsoft.com/library/windows/hardware/br259124.aspx”).

Such a version 4 printer driver model can be roughly divided into two layers of a printer driver section and a print setup UI (User Interface) section as the structure. These two layers are designed so as to separate their processes from each other, which realizes that the two layers can be provided separately.

The printer driver section provides print features for users and is composed of data files including a GPD (Generic Printer Description) or PPD (PostScript Printer Description) file and a XML (Extensive Markup Language) file, a localization resource DLL (Dynamic Link Library), a print filter and various modules including a JavaScript constraint section (JAVASCRIPT is a registered trademark of Oracle America, Inc.). The GPD/PPD file defines various print features, and the localization resource DLLs defines display strings (character strings) to be displayed in plural languages for each of the print features. The printer filter is configured to edit rendering commands in rendering processing. The JavaScript constraint section handles a conflict among setup items about the print features.

The print setup UI section is independent from the printer driver section, and provides a print setup screen based on print capability information called as PrintCapabilities and print setup information called as PrintTicket. PrintCapabilities is described in the XML format and includes definitions of the various print features. As a concrete example, for an alternative-type feature (which requires a choice from plural optional items), PrintCapabilities includes descriptions about a feature, available options for the feature and display strings of the feature and the options. For a feature which requires an input of a string, PrintCapabilities includes descriptions about a parameter, a property such as the maximum number of characters and the minimum number of characters and a display string for the name of the parameter.

As an example of technologies relating to such a version 4 printer driver model, Japanese Unexamined Patent Publication (JP-A) No. 2011-023019 discloses the following information processing apparatus. The information processing apparatus is connected to an external device through a communication network. The information processing apparatus includes a receiving section, a status acquiring section, a resource acquiring section and a transmitting section. The receiving section is configured to receive a request from another image processing apparatus, where the request includes designations of both of information representing a display style of a display program set in the another information processing apparatus and information representing a type of a status. The status acquiring section is configured to acquire the value of the status corresponding to the type from the external device based on the information representing the type of the status included in the request. The resource acquiring section is configured to acquire resource information corresponding to the information representing the display style of the display program included in the request. The transmitting section is configured to, in response to the request received by the receiving section, transmit the status information according to the resource information acquired by the resource acquiring section and the value of the status corresponding to the type.

In the conventional apparatus, there is provided the following construction for display strings to be displayed by the print setup UI section. The construction is configured such that, by designating a resource ID included in a localization resource DLL when defining print features in the GPD/PPD file, a display string is automatically reflected on PrintCapabilities. However, since there is a restriction that only alternative-type features are allowed to be defined in a GPD/PPD file because of the specifications, it is required, when defining a feature requiring an input of a string, to add information about the feature to PrintCapabilities inside the JavaScript constraint section. In this process, a display string cannot be set into PrintCapabilities for the feature requiring an input of a string, because display strings are not allowed to be obtained from the localization resource DLL in the JavaScript constraint section, which was a problem.

To solve the problem, there can be considered a method to set a display string into PrintCapabilities by hardcoding inside the JavaScript constraint section. In this method, the display string which has been set by hardcoding, in other words, the display string about the feature (requiring an input of a string) added by the JavaScript constraint section, is not changed into another language according to the OS language, while a display string which has been designated by a resource ID, in other words, a display string about a feature (an alternative-type feature) defined in the GPD/PPD file, is automatically changed into another language according to the OS language. Such the situation makes an inconsistency in language between display strings for features defined in the GPD/PPD file and display strings for features added in the JavaScript constraint section, when the OS language has been changed.

As another method to solve the above problem, there can be considered a method to put display strings inside the print setup UI section. However, in this method, display strings are held in plural positions in the printer driver section and the print setup UI section separately, which makes time and efforts to manage the display strings (for example, to associate display strings which are held by both sections with each other). The present invention seeks to solve the problem.

### SUMMARY

There are disclosed illustrative non-transitory computer-readable storage media each storing a printer driver and illustrative localization methods for the printer driver.

An illustrative non-transitory computer-readable storage medium reflecting one aspect of the present invention stores a printer driver to be executed in a computing device. The computing device includes a display section configured to display a print setup screen which allows a user to set print features thereon. The printer driver, when being executed by a processor of the computing device, causes the computing device to perform the following processing. The processing comprises creating print capability information based on a configuration file and a localization resource file. The localization resource file includes definitions of strings about the print features. The configuration file includes definitions of the print features and a definition of a dummy feature which do not affect the print features, where the definition of the dummy feature includes a designation of one of the strings defined in the localization resource file. The print capability information includes descriptions of setup items of the print features, descriptions of option values which can be set for each of the setup items, and the one of the strings designated in the definition of the dummy feature. The processing further comprises, on handling a conflict among the setup items of the print features in the print capability information, adding a description of a feature as an added feature which is not allowed to be defined in the configuration file, into the print capability information, and reflecting the one of the strings designated in the definition of the dummy feature on the description of the added feature; and creating the print setup screen on which the one of the strings is displayed with being associated with the added feature, based on the print capability information in which the one of the strings has been reflected on the description of the added feature.

Another illustrative non-transitory computer-readable storage medium reflecting one aspect of the present invention stores a printer driver to be executed in a computing device. The computing device includes a display section configured to display a print setup screen which allows a user to set print features thereon. The printer driver, when being executed by a processor of the computing device, causes the computing device to perform the following processing. The processing comprises creating print capability information based on a configuration file and a localization resource file. The localization resource file includes definitions of strings about the print features. The configuration file includes definitions of the print features and a definition of a dummy feature which do not affect the print features, where the definition of the dummy feature includes a designation of one of the strings defined in the localization resource file. The print capability information includes descriptions of setup items of the print features, descriptions of option values which can be set for each of the setup items, and the one of the strings designated in the definition of the dummy feature. The processing further comprises, on handling a conflict among the setup items of the print features in the print capability information, reflecting the one of the strings designated in the definition of the dummy feature on the print capability information; and creating the print setup screen on which the one of the strings is displayed, based on the print capability information on which the one of the strings has been reflected.

An illustrative localization method for a printer driver reflecting one aspect of the present invention is a localization method for a printer driver being capable of creating a print setup screen which is displayed on a display section of a computing device and allows a user to set print features thereon. The method comprises: adding a definition of a dummy feature which do not affect the print features into a configuration file, where the configuration file includes definitions of the print features. The method further comprises designating a string managed by a localization resource file in the definition of the dummy feature, where the localization resource file includes definitions of strings about the print features. The method further comprises creating print capability information based on the configuration file and the localization resource file, where the print capability information includes descriptions of setup items of the print features, descriptions of option values which can be set for each of the setup items, and the string designated in the definition of the dummy feature. The method further comprises, on handling a conflict among the setup items of the print features in the print capability information, adding a description of a feature as an added feature which is not allowed to be defined in the configuration file, into the print capability information, and reflecting the string designated in the definition of the dummy feature on the description of the added feature; and creating the print setup screen on which the string is displayed with being associated with the added feature, based on the print capability information in which the string has been reflected on the description of the added feature.

Another illustrative localization method for a printer driver reflecting one aspect of the present invention is a localization method for a printer driver being capable of creating a print setup screen which is displayed on a display section of a computing device and allows a user to set print features thereon. The method comprises: adding a definition of a dummy feature which do not affect the print features into a configuration file, where the configuration file includes definitions of the print features. The method further comprises designating a string managed by a localization resource file in the definition of the dummy feature, where the localization resource file includes definitions of strings about the print features. The method further comprises creating print capability information based on the configuration file and the localization resource file, where the print capability information includes descriptions of setup items of the print features, descriptions of option values which can be set for each of the setup items, and the string designated in the definition of the dummy feature. The method further comprises, on handling a conflict among the setup items of the print features in the print capability information, reflecting the string designated in the definition of the dummy feature on the print capability information; and creating the print setup screen on which the string is displayed, based on the print capability information on which the string has been reflected.

Other features of illustrative embodiments will be described below.

### BRIEF DESCRIPTION OF THE DRAWINGS

Embodiments will now be described, by way of example only, with reference to the accompanying drawings which are meant to be exemplary, not limiting, and wherein like elements numbered alike in several figures, in which:

FIG. 1 is a diagram schematically illustrating a constitution of a printing system relating to one embodiment of the present invention;

FIG. 2 is a block diagram illustrating a constitution of a computing device relating to one embodiment of the present invention;

FIG. 3 is a functional block diagram of a computing device relating to one embodiment of the present invention;

FIG. 4 illustrates an example of a GPD file relating to one embodiment of the present invention;

FIG. 5 illustrates an example of a localization resource DLL relating to one embodiment of the present invention;

FIG. 6 illustrates an example of description of processing executed by the JavaScript constraint section relating to one embodiment of the present invention;

FIG. 7 illustrates an example of PrintCapabilities (before being edited by the JavaScript constraint section) relating to one embodiment of the present invention;

FIG. 8 illustrates an example of PrintCapabilities (after being edited by the JavaScript constraint section) relating to one embodiment of the present invention;

FIG. 9 illustrates an example of a print setup screen displayed by a print setup UI section relating to one embodiment of the present invention;

FIG. 10 is a diagram illustrating data flow between sections of the computing device relating to one embodiment of the present invention;

FIG. 11 is a flowchart illustrating processing of the computing device (processing to display a print setup screen) relating to one embodiment of the present invention; and

FIG. 12 is a flowchart illustrating processing of the computing device (processing to edit PrintCapabilities by the JavaScript constraint section) relating to one embodiment of the present invention.

### DETAILED DESCRIPTION

Illustrative embodiments of non-transitory computer-readable storage media each storing a printer driver and localization methods for the printer driver will be described with reference to the drawings. It will be appreciated by those of ordinary skill in the art that the description given herein with respect to those figures is for exemplary purposes only and is not intended in any way to limit the scope of potential embodiments may be resolved by referring to the appended claims.

According to the non-transitory computer-readable storage media each storing a printer driver and localization methods for the printer driver as the illustrative embodiments, an inconsistency about display strings in language can be prevented and strings can be displayed for arbitrary features with being managed together because of the following reason.

There is provided the following method or processing on creating a setup screen of print features to be displayed on a display section of a computing device, based on a configuration file such as a GPD file and on a localization resource file (a localization resource DLL). In the method or processing, a dummy feature which does not affect the print features is defined in the configuration file, and a string which is managed in the localization resource file is designated in the definition of the dummy feature. Based on the configuration file including the definition of the dummy feature and on the localization resource file, print capability information (PrintCapabilities) is created. Then, the print capability information is edited by using JavaScript, where a description of a feature (preferably, a feature which is not allowed to be defined in the configuration file) is added to the print capability information and the string designated in the definition of the dummy feature is reflected (set) on the description of the added feature. Then, the setup screen is created based on the edited print capability information.

According to the above method or processing, even for features which are not allowed to be defined in the configuration file, strings managed in the localization resource DLL can be displayed on the setup screen in the same manner as strings for features which are allowed to be defined in the configuration file.

As illustrated in the descriptions about the background, hardware manufactures provide printer drivers for Windows operating systems and are further developing version 4 printer drivers for new Windows operating systems such as Windows 8 and Windows Server 2012.

Such a version 4 printer driver is composed of two layers including a printer driver section and a print setup UI section. The printer driver section is provided with data files such as a GPD or PPD file, a localization resource DLL, a print filter and various modules such as a JavaScript constraint section. The printer driver section is configured to provide information such as PrintCapabilities and PrintTicket for the print setup UI section. The print setup UI section is configured to provide a print setup screen based on the provided information.

Regarding features which are allowed to be defined in the GPD/PPD file (alternative-type features) because of the specifications of the printer driver, a resource ID associated with a string is designated in the GPD or PPD file, and thereby, the string corresponding to the resource ID is automatically incorporated into PrintCapabilities when the printer driver section creates the PrintCapabilities based on the GPD or PPD file. When the print setup UI section creates a print setup screen according to the PrintCapabilities, strings managed in the localization resource DLL can be displayed on the print setup screen.

On the other hand, regarding features which are not allowed to be defined in the GPD/PPD file (features requiring an input of a string) because of the specifications, the printer driver section may be configured to just edit the PrinteCapabilities which was created based on the GPD or PPD file, by using the JavaScript constraint section to add a concerned feature into the PrinteCapabilities if only the concerned feature is going to be realized. Further, regarding a string to be displayed (a display string) for the feature, the printer driver section may be configured to set the string inside the JavaScript constraint section by using hardcoding.

However, display strings set by using hardcoding are not automatically changed in language corresponding to a change of the OS language, which is different from display strings designated by resource IDs. It can cause an inconsistency of display strings in language when the OS language is changed. Alternatively, there can be considered a way to put display strings inside the print setup UI section. However, display strings are held by both of the printer driver section and the print setup UI section in this way, which requires additional processing for a management of the strings such as associating display strings in the both sections with each other.

On the other hand, a version 3 printer driver which was developed on the assumption to be used with the operating systems from Windows 2000 to Windows 7, was designed to provide a set of a printer driver section and a print setup UI section. In such a printer driver, a module to create PrintCapabilities and the print setup UI section can directly access a localization resource DLL to read the display strings. Therefore, the printer driver can reflect display strings even on features which are not allowed to be defined in the GPD/PPD file because of the specification, by referring to the localization resource DLL when editing PrintCapabilities or creating a print setup screen based on the PrintCapabilities.

In other words, the above problem has been newly caused in version 4 printer driver models, which are composed of the printer driver section and the print setup UI section provided as separated layers and have a restriction that the JavaScript constraint section is not allowed to access a localization resource DLL because of the specification. A way to solve the problem is now required on developing such the Version 4 printer drivers.

In view of the above problem, there are provided the following localization method for a printer driver and a non-transitory computer-readable storage medium storing a printer driver causing a processor of a computing device to perform the following processing. First, regarding features which are not allowed to be defined in a configuration file such as a GPD/PPD file because of the specifications, display strings are registered in a localization resource DLL. In the GPD/PPD file, a dummy feature is defined as an alternative-type feature which can be defined in the file according to the specification, and a resource ID is designated in the definition of the dummy feature so that a concerned display string is reflected on (set in) PrintCapabilities. In this process, a property not to display the dummy feature onto the print setup screen is preferably added to the definition of the dummy feature. That is, the dummy feature is described in the GPD/PPD file in the similar form to features which are allowed to be defined in the GPD/PPD file, but the feature is set not to be displayed on the print setup screen in the description. When the printer driver section creates PrintCapabilities based on the above GPD/PPD file and the localization resource DLL, the created PrintCapabilities includes a description of the display string corresponding to the resource ID. After that, when the JavaScript constraint section edits the PrintCapabilities, the JavaScript constraint section defines a feature to be added in the PrintCapabilities and associates the display string described for the dummy feature with the feature to be added.

Such the processing allows a computing device to display even a display string designated by the resource ID for a feature which is not allowed to be defined in the GPD/PPD file (for example, a feature which requires an input of a string, such as an user ID setting and a password setting) because of the specification, and allows the computing device to change the language of the strings automatically corresponding to a change of the OS language, similarly to features which are allowed to be defined in the GPD/PPD file because of the specification. Further, such the processing allows definitions of the display strings to be put into the localization resource DLL together. Thereby, problems can be caused in the version 4 printer driver models can be solved.

### EXAMPLE

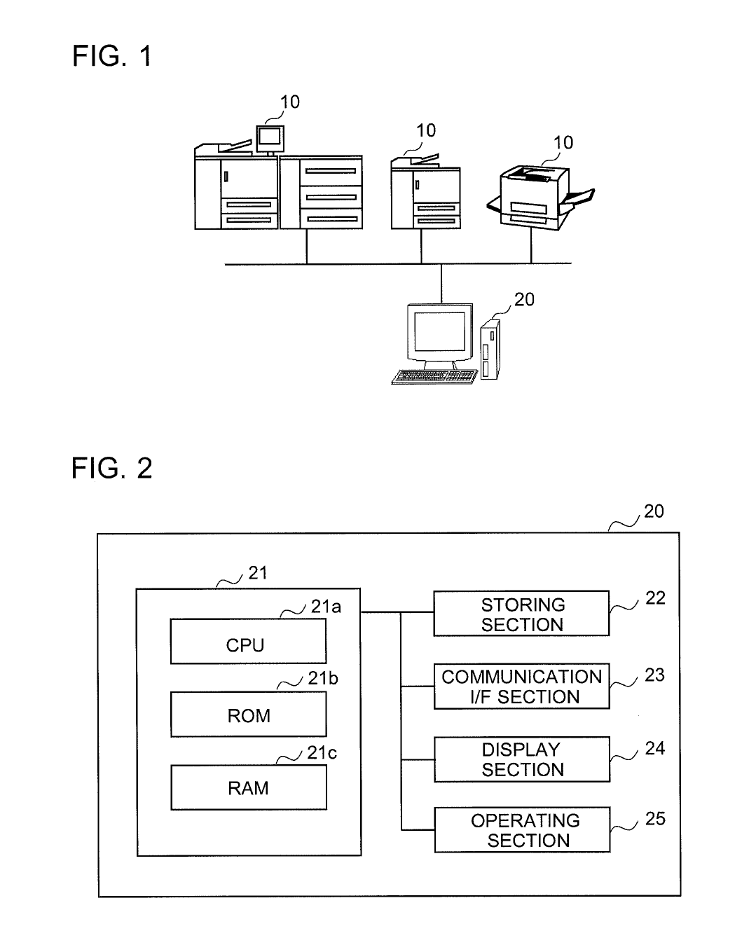

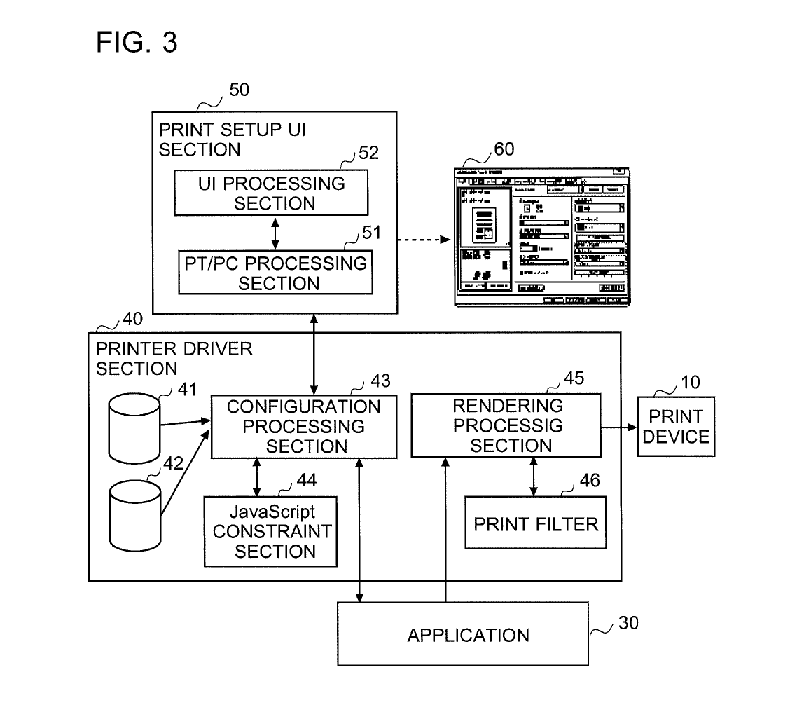

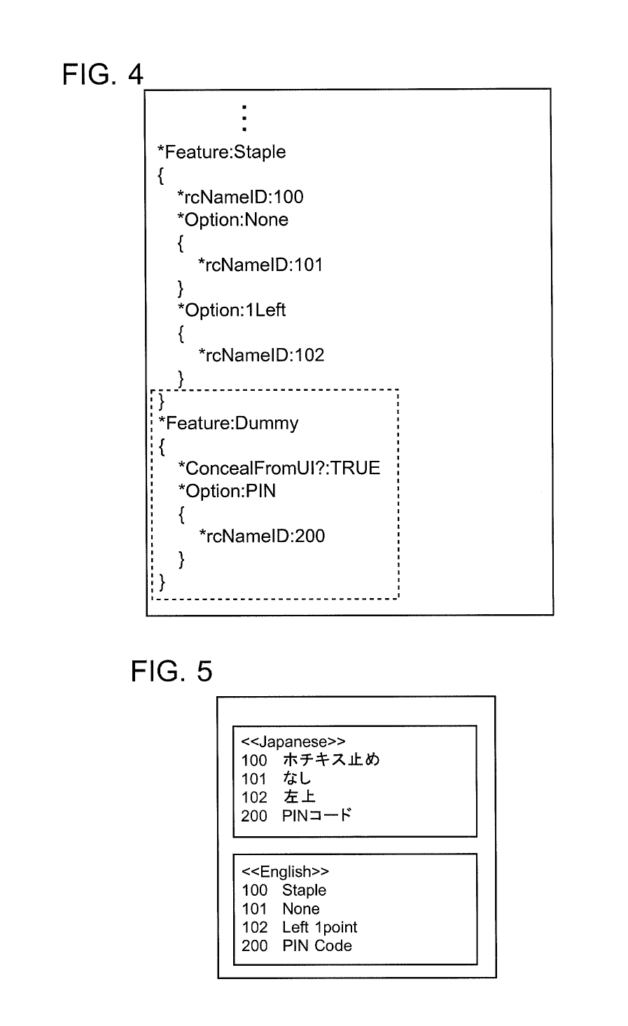

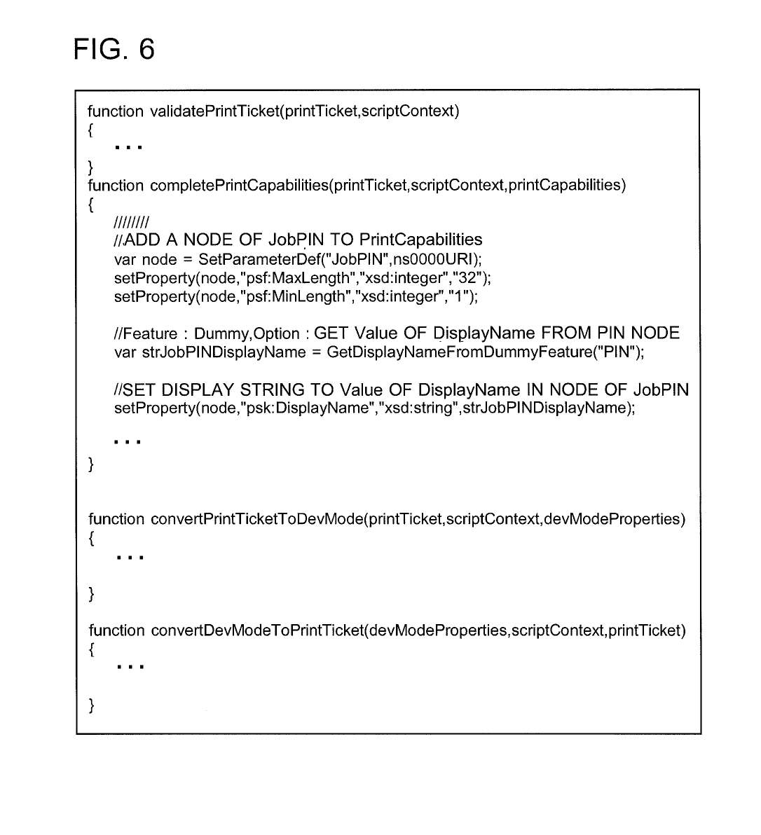

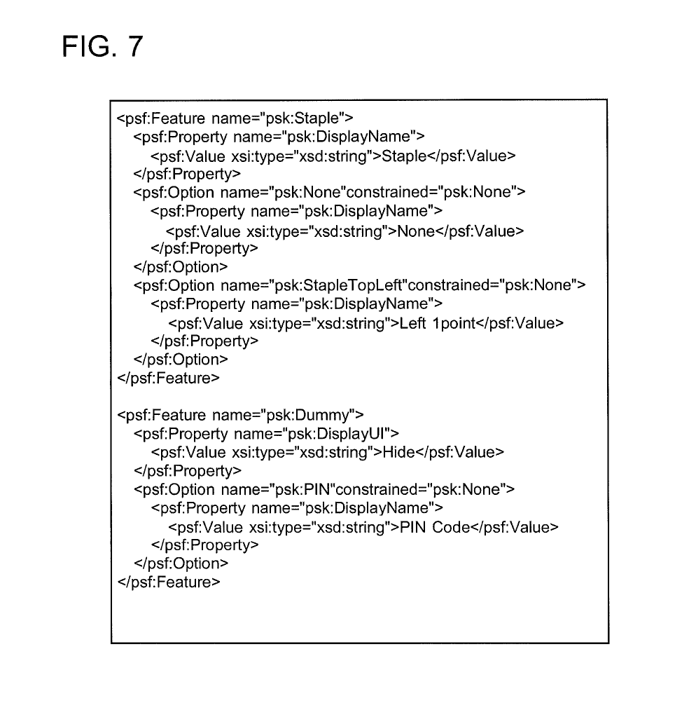

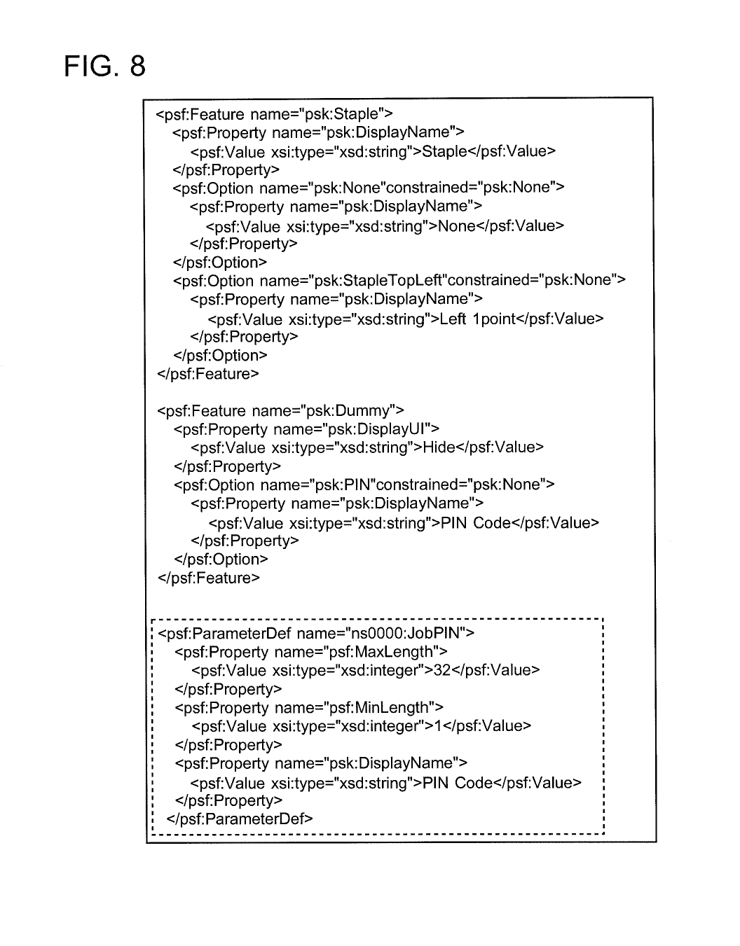

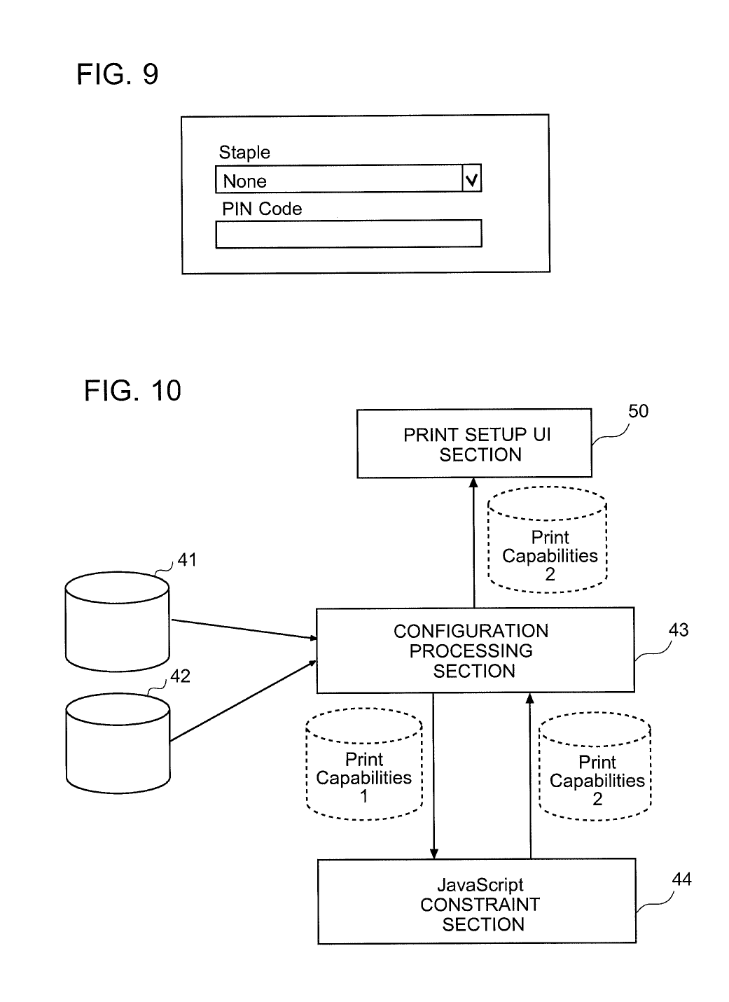

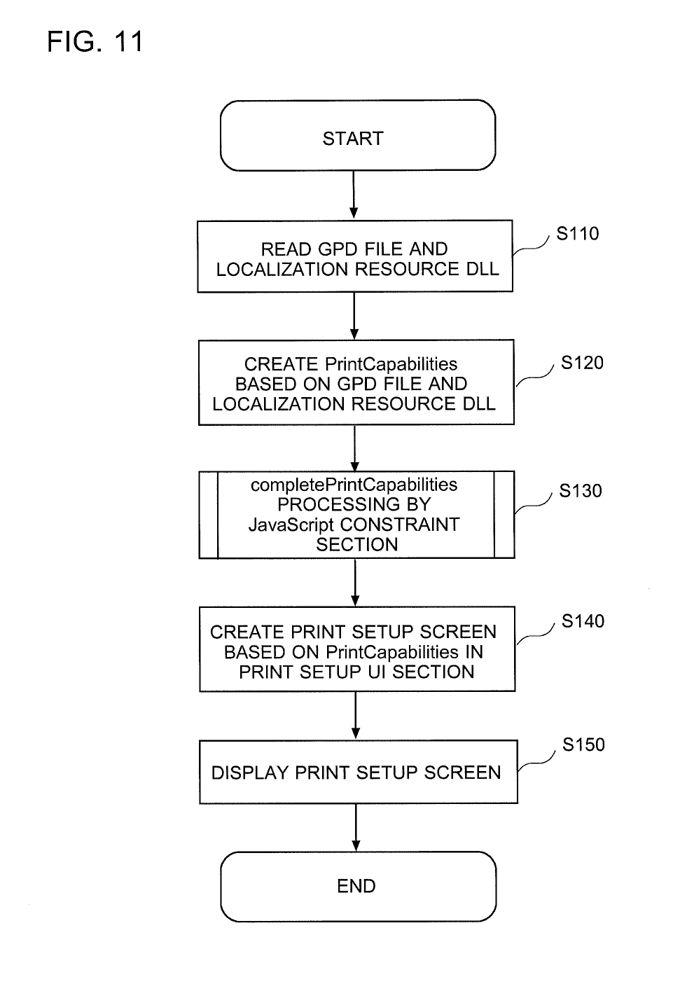

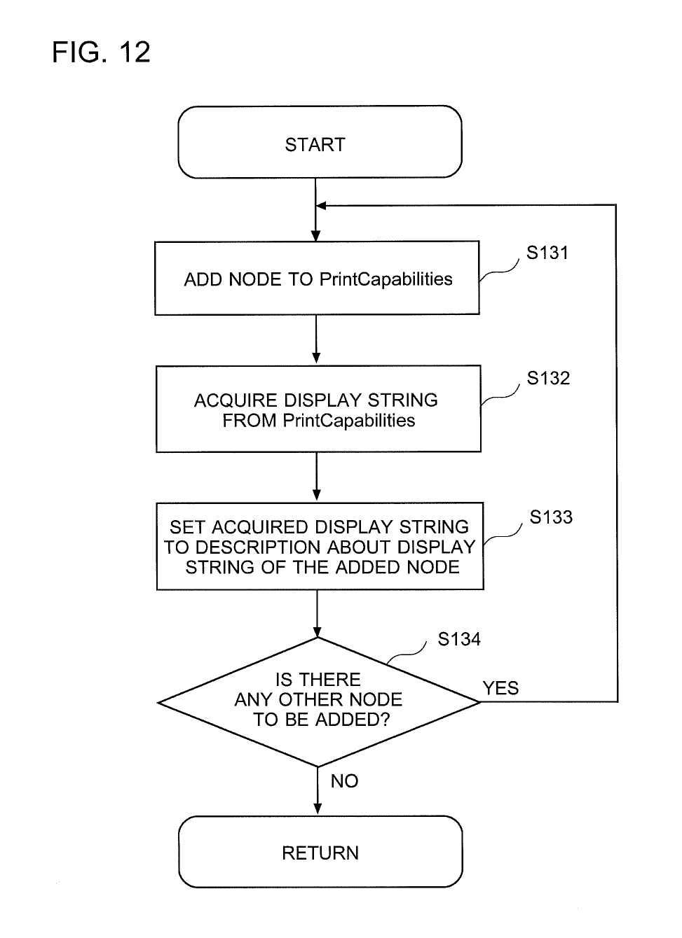

In order to describe the above-mentioned embodiments in more detail, description will be given to a non-transitory computer-readable storage media each storing a printer driver and localization methods for the printer driver pertaining to one example of the present invention with reference to FIGS. 1 to 12. FIG. 1 is a diagram schematically illustrating a constitution of a printing system of the present example. FIG. 2 is a block diagram illustrating a constitution of a computing device of the present example. FIG. 3 is a functional block diagram of a computing device of the present example. FIGS. 4 and 5 illustrate examples of a GPD file and a resource DLL, respectively. FIG. 6 illustrates an example of a description about processing executed by the JavaScript constraint section. FIGS. 7 and 8 illustrate examples of PrintCapabilities. FIG. 9 illustrates an example of a print setup screen displayed by a print setup UI section. FIG. 10 is a diagram illustrating data flow between sections of the computing device of the present example. Each of FIGS. 11 and 12 is a flowchart illustrating processing of the computing device of the present example.

As shown in FIG. 1, a printing system of the present example is composed of print devices 10 configured to execute print processing according to print instructions, and a print instructing device (hereinafter, referred as a computing device 20). The print devices 10 and the computing device 20 are connected together with a wireless network such as a LAN (Local Area Network) or a wired network through USBs (Universal Serial Bus) of respective devices.

Print devices 10 can be commonly-known printers and MFPs (Multi Function Peripherals) and are configured to analyze print data sent from computing device 20, rasterize respective pages of the print data, create image data for the respective pages and print images based on the image data by using an image forming process such as an electrophotograpic process and an electrostatic printing process.

Computing device 20 can be a personal computer or a mobile device (such as a smart phones and a tablet terminal). Computing device 20 is composed of components including control section 21, storing section 22, communication interface (I/F) section 23, display section 24 and operating section 25, as shown in FIG. 2.

Control section 21 is composed of components including a CPU (Central Processing Unit) 21a and storage devices such as a ROM (Read Only Memory) and a RAM (Random Access Memory) 21c. CPU 21a is configured to read various programs stored in ROM 21b or storing section 22, and then, develop and execute the programs on RAM 21 c to implement various functions, where the various programs include programs for controlling operations of computing device 20, an operating system (in the present example, Windows operating system on which a Version 4 printer driver can be executed), application programs and a printer driver for controlling print devices 10 (in the present example, a Version 4 printer driver including a printer driver section and a print setup UI section which are arranged in separated layers). The application programs, the printer driver section and the print setup UI section will be described later.

Storing section 22 includes a HDD (Hard Disc Drive) to store various programs, document data and print data.

Communication interface section 23 is composed of a device such as a NIC (Network Interface Card) and a modem, and is configured to perform data communication with print devices 10 through a wireless network or a wired network.

Display section 24 includes a device such as a LCD (Liquid Crystal Display), and is configured to display screens of application programs and screens created by the print setup UI section.

Operating section 25 is composed of devices such as a mouse, a keyboard and a touch sensor formed on display section 24, and is configured to allow a user to perform operations such as creating documents and setting print features of print devices 10.

FIG. 3 is a block diagram illustrating functions and sections realized by control section 21 of computing device 20. Control section 21 of computing device 20 executes application programs 30 and executes a printer driver to realize functions of printer driver section 40 and print setup UI section 50.

Application program 30 is a program to run on an operating system (for example, Microsoft Office which can run on Windows operating systems) and to create document data to be printed.

Printer driver section 40 is provided as a program to run on an operating system and is configured to send a print instruction to print device 10 in cooperation with application program 30 and print setup UI section 50. The printer driver section 40 is composed of GPD file 41, localization resource DLL 42, configuration processing section 43, JavaScript constraint section 44, rendering processing section 45 and print filter 46.

GPD file 41 is one of configuration files and includes definitions of various print features of print device 10. Localization resource DLL 42 is a resource file to provide information for localizing a printer driver and includes definitions of display strings about the print features to be displayed on print setup screen 60 by print setup UI section 50. Configuration processing section 43 is configured to perform the following processing. Configuration processing section 43 creates PrintCapabilities (print capability information) based on GPD file 41 and localization resource DLL 42, where PrintCapabilities includes descriptions of setup items of the print features which can be set by users and descriptions of option values available for each setup item of the printing features both described in XML format. Configuration processing section 43 further creates PrintTicket (print setup information) which includes descriptions of an option value for each setup item, chosen by a user from among the option values described in PrintCapabilities, and invokes JavaScript constraint section 44.

JavaScript constraint section 44 is configured to handle a conflict among setup items of the print features. For example, under the situation that a setting for a first feature (for example, an imposition feature) and a setting for a second feature (for example, a punching feature) are incompatible, JavaScript constraint section 44 changes one of the settings to be compatible with the other. Further, JavaScript constraint section 44 is configured to edit PrintCapabilities by using JavaScript. Rendering processing section 45 is configured to convert print instructions sent from application program 30 into descriptions in language which can be interpreted by print device 10, for example, the PDL (Page Description Language). Print filter 46 is configured to edit instructions for drawing in a rendering process.

Print setup UI section 50 is provided as a program to run on the operating system and is composed of PT/PC processing section 51 and UI processing section 52.

PT/PC processing section 51 is configured to process (interpret) PrintTicket/PrintCapabilities obtained from printer driver section 40. UI processing section 52 is configured to create and display print setup screen 60 based on the contents of the PrintTicket/PrintCapabilities which has been interpreted by PT/PC processing section 51.

In the present example, there are given descriptions about a localization method or processing under the situation that GPD file 41 is used as a configuration file to define the print features. Alternatively, the localization method or processing of the present example is applicable similarly to the situation that a PPD file is used as the configuration file.

Hereinafter, the way to define display strings into PrintCapabilities created by configuration processing section 43 will be descried in more detail with reference to a concrete example of the data description.

FIG. 4 illustrates an example of a description of GPD file 41. Each print feature is defined at “*Feature:” shown in FIG. 4. An option value of each print feature are defined at “*Option:”, shown in FIG. 4, as a child element of the “*Feature”. An identifier to be used for obtaining a display string defined (managed) in localization resource DLL 42 is defined at “*rcNameID:” (that is, a resource ID is designated at this description).

It is noted in the present example, that a description of “*Feature:Dummy” (the description enclosed by broken lines) is added to the above GPD file 41 for defining a “Dummy” feature which do not affect the print features. Further, the definition of “*Option:” as a child element of “*Feature:Dummy” includes a definition to obtain a display string from localization resource DLL 42 (a definition to designate the display string of resource ID 200 which has been defined in localization resource DLL 42 and to obtain the display string). The description of “*ConcealFromUI?:TRUE” as a child element of “*Feature:Dummy” defines a designation not to display the “Dummy” feature onto the print setup screen, which adds a property not to display the “Dummy” feature onto the print setup screen to the “Dummy” feature.

FIG. 5 illustrates an example of a description of localization resource DLL 42. Localization resource DLL 42 includes definitions of display strings in multiple languages (Japanese and English in this example), where sets of an identifier and a display string are defined for each language. For example, in one of the definitions, a string corresponding to the identifier (resource ID) of 100 is defined as a display string corresponding to a stapling feature. In the localization resource DLL 42, languages of display strings are not limited to Japanese and English and arbitrary languages may be employed according to the language of the current Windows operating system.

FIG. 6 illustrates an example of a description of processing to be executed by JavaScript constraint section 44. In the description, completePrintCapabilities function is a function to edit PrintCapabilities and is invocated by configuration processing section 43 when print setup UI section 50 displays a print setup screen. Since features each requiring an input of a string are not allowed to be defined in GPD file 41, processing to add such the features is described in the description of processing to be executed by JavaScript constraint section 44.

In this example, a PIN code feature which is a feature to implement a string input in the function is added into PrintCapabilities by using descriptions of “var node=SetparameterDef(“JobPIN”, ns000URI)”, “setProperty(node, “psf:MaxLength”, “xsd:integer”, “32”);”, and “setProperty(node, “psf:MinLength”, “xsd:integer”, “1”);”. Further, when the PIN code feature is added, a display string is acquired from the node of “<psf:Feature name=”psk:Dummy“>” in PrintCapabilities by using descriptions of “var strJobPINDisplayName =GetDisplayNameFromDummyFeature(“PIN”);”, and the acquired display string is set to the display string of the node of the PIN code feature which has been newly added, by using descriptions of “setProperty(node, “psk:DisplayName”, “xsd:string”, strJobPINDisplayName);”.

FIG. 7 illustrates an example of a description of PrintCapabilities created based on GPD file shown in FIG. 4 and localization resource DLL 42 shown in FIG. 5. This PrintCapabilities is used as a parameter when completePrintCapabilities function in JavaScript constraint section 44 shown in FIG. 6 is invoked.

FIG. 8 illustrates an example of a description of PrintCapabilities which has been processed by JavaScript constraint section 44. JavaScript constraint section 44 adds the nodes of the PIN code feature represented by “<psf:ParameterDef name=“ns0000:JobPIN”>” and the succeeding lines in the broken-lined frame in FIG. 8.

FIG. 9 illustrates an example of print setup screen 60. In the present example, the display string “PIN Code” is displayed with being associated with the box where a PIN code should be inputted for the PIN code feature, based on the description of PrintCapabilities shown in FIG. 8.

FIG. 10 is a diagram illustrating flow of data shown in FIGS. 4 to 9 among the sections. On defining a display string for a feature which is not allowed to be defined in GPD file 41 (a feature requiring an input of a string), the following processes are implemented. As described above, there is provided GPD file 41, and a definition of a dummy feature which does not affect the print features and is defined in the same manner as alternative-type features is added into the GPD file 41. Further, a display string is defined by adding a designation of the resource ID managed in localization resource DLL 42 into the definition of the dummy feature. Configuration processing section 43 creates PrintCapabilities (PrintCapabilities 1 in FIG. 10) including a description of the display string designated in the definition of the dummy feature, based on the GPD file 41 and localization resource DLL 42. When JavaScript constraint section 44 handles a conflict of setup items of print features described in the created PrintCapabilities, the JavaScript constraint section 44 edits the description of PrintCapabilities by using JavaScript. In this process, the JavaScript constraint section 44 adds a definition of a feature which requires an input of a string, into PrintCapabilities, acquires the display string in the definition of the dummy feature, and sets (reflects) the display string into the description of the added feature which requires an input of a string. Then, JavaScript constraint section 44 provides the edited PrintCapabilities (PrintCapabilities 2 in FIG. 10) for print setup UI section 50. Thereby, even for a feature which is not allowed to be defined in GPD file 41, a display string can be displayed in the print setup screen with being associated with the added feature, in the same manner as display strings for features which are allowed to be defined in GPD file 41.

Hereinafter, processing (processing of displaying print setup screen 60) to be implemented in each computing device 20 of the present example will be described with reference to flow charts illustrated in FIGS. 11 and 12.

As described above, there is provided GPD file 41 including a definition of a dummy feature which does not affect the print features and is defined in the same manner as the alternative-type features, and a display string is defined by adding a designation of its resource ID into the definition of the dummy feature. Then, configuration processing section 43 reads GPD file 41 and localization resource DLL 42 (S110) and create PrintCapabilities based on GPD file 41 and localization resource DLL 42 (S120).

Next, JavaScript constraint section 44 edits PrintCapabilities by using completePrintCapabilities function (S130), which is illustrated in FIG. 12 in more detail. First, JavaScript constraint section 44 newly adds a feature requiring an input of a string (for example, a feature for which a PIN code is inputted) into PrintCapabilities received from configuration processing section 43 (S131). Then, JavaScript constraint section 44 acquires a display string described in the definition of the dummy feature (for example, a string “PIN Code”) (S132), and adds (reflects) the acquired display string into the description about the display string in the newly added feature (S133). For example, in PrintCapabilities shown in FIG. 8, JavaScript constraint section 44 adds “<psf:Value xsi:type=”xsd:string“>PIN Code</psf:Value>” in the node of “<psf:Feature name=”psk:Dummy“>” into “<psf:Property name=”psk:DisplayName“>” in the node of “<psf:ParameterDef name=”ns000:JobPIN“>”. After that, JavaScript constraint section 44 determines whether there is any other node to be added or not (S134), and if there is a node to be added, returns to S131 and repeats the similar processing.

Returning to FIG. 11, configuration processing section 43 sends the edited PrintCapabilities by JavaScript constraint section 44 together with PrintTicket, to print setup UI section 50. PT/PC processing section 51 of print setup UI section 50 processes the PrintCapabilities. UI processing section 52 creates a print setup screen (for example, a screen displaying a string “PIN Code” for a feature for which a PIN code is inputted as shown in FIG. 9) based on the result of the processing of PT/PC processing section 51 (S140) and displays the created print setup screen onto display section 24 (S150).

The above processing allows display strings managed by localization resource DLL 42 to be reflected on (set into) a print setup screen created by UI processing section 52, even for a feature which is not allowed be defined in GPD file 41, which can avoid an inconsistency of display strings in language caused corresponding to a change of the OS and an occurrence of time and effort required for managing the display strings before they happen.

The scope of the present invention is not limited to the aforementioned examples. Disclosed configurations of the aforementioned printer driver and the disclosed localization method of the same of the aforementioned embodiments of the present invention can be varied by a skilled person without departing from the spirit and scope of the invention.

For example, the above-mentioned example illustrated about processing to display a string managed by localization resource DLL, for a feature requiring an input of a string. However, a string defined by using a dummy feature can be displayed for any other feature which is not allowed to be defined in GPD file 41 (for example, a feature to display a string in an arbitrary area, such as a tab, in the print setup screen). That is, the following processing may be provided. There is provided GPD file 41, wherein a definition of a dummy feature which does not affect the print features is added, and a display string is defined by adding a designation of the resource ID managed in localization resource DLL 42 into the definition of the dummy feature. Configuration processing section 43 creates PrintCapabilities including a description of the display string designated in the definition of the dummy feature, based on the GPD file 41 and localization resource DLL 42. When JavaScript constraint section 44 handles a conflict of setup items of print features described in the created PrintCapabilities, the JavaScript constraint section 44 edits the description of PrintCapabilities by using JavaScript so as to set (reflect) the display string described in the definition of the dummy feature to a corresponding description of the PrintCapabilities. Then, JavaScript constraint section 44 provides the edited PrintCapabilities for print setup UI section 50. Thereby, the display string designated in the definition of the dummy feature can be displayed in the print setup screen by print setup UI section 50.

1. A non-transitory computer-readable storage medium storing a printer driver to be executed in a computing device, the computing device including a display section configured to display a print setup screen which allows a user to set print features thereon, the printer driver, when being executed by a processor of the computing device, causing the computing device to perform processing comprising:
creating print capability information based on a configuration file and a localization resource file, the localization resource file including definitions of strings about the print features, the configuration file including definitions of the print features and a definition of a dummy feature which do not affect the print features, the definition of the dummy feature including a designation of one of the strings defined in the localization resource file, the print capability information including descriptions of setup items of the print features, descriptions of option values which can be set for each of the setup items, and the one of the strings designated in the definition of the dummy feature;
on handling a conflict among the setup items of the print features in the print capability information, adding a description of a feature as an added feature which is not allowed to be defined in the configuration file, into the print capability information, and reflecting the one of the strings designated in the definition of the dummy feature on the description of the added feature; and
creating the print setup screen on which the one of the strings is displayed with being associated with the added feature, based on the print capability information in which the one of the strings has been reflected on the description of the added feature.

2. The non-transitory computer-readable storage medium of claim 1,
wherein the configuration file is a GPD file, and the print capability information is a PrintCapabilities document.

3. The non-transitory computer-readable storage medium of claim 1,
wherein the definition of the dummy feature includes a property not to display the dummy feature on the print setup screen.

4. The non-transitory computer-readable storage medium of claim 1,
the printer driver is a version 4 printer driver to be executed on a Windows (a registered trademark) operating system.

5. A non-transitory computer-readable storage medium storing a printer driver to be executed in a computing device, the computing device including a display section configured to display a print setup screen which allows a user to set print features thereon, the printer driver, when being executed by a processor of the computing device, causing the computing device to perform processing comprising:
creating print capability information based on a configuration file and a localization resource file, the localization resource file including definitions of strings about the print features, the configuration file including definitions of the print features and a definition of a dummy feature which do not affect the print features, the definition of the dummy feature including a designation of one of the strings defined in the localization resource file, the print capability information including descriptions of setup items of the print features, descriptions of option values which can be set for each of the setup items, and the one of the strings designated in the definition of the dummy feature;
on handling a conflict among the setup items of the print features in the print capability information, reflecting the one of the strings designated in the definition of the dummy feature on the print capability information; and
creating the print setup screen on which the one of the strings is displayed, based on the print capability information on which the one of the strings has been reflected.

6. The non-transitory computer-readable storage medium of claim 5,
wherein the configuration file is a GPD file, and the print capability information is a PrintCapabilities document.

7. The non-transitory computer-readable storage medium of claim 5,
wherein the definition of the dummy feature includes a property not to display the dummy feature on the print setup screen.

8. The non-transitory computer-readable storage medium of claim 5,
the printer driver is a version 4 printer driver to be executed on a Windows (a registered trademark) operating system.

9. A localization method for a printer driver being capable of creating a print setup screen which is displayed on a display section of a computing device and allows a user to set print features thereon, the method comprising:
adding a definition of a dummy feature which do not affect the print features into a configuration file, the configuration file including definitions of the print features;
designating a string managed by a localization resource file in the definition of the dummy feature, the localization resource file including definitions of strings about the print features;
creating print capability information based on the configuration file and the localization resource file, the print capability information including descriptions of setup items of the print features, descriptions of option values which can be set for each of the setup items, and the string designated in the definition of the dummy feature;
on handling a conflict among the setup items of the print features in the print capability information, adding a description of a feature as an added feature which is not allowed to be defined in the configuration file, into the print capability information, and reflecting the string designated in the definition of the dummy feature on the description of the added feature; and
creating the print setup screen on which the string is displayed with being associated with the added feature, based on the print capability information in which the string has been reflected on the description of the added feature.

10. The localization method of claim 9,
wherein the configuration file is a GPD file, and the print capability information is a PrintCapabilities document.

11. The localization method of claim 9,
wherein the definition of the dummy feature includes a property not to display the dummy feature on the print setup screen.

12. The localization method of claim 9,
the printer driver is a version 4 printer driver to be executed on a Windows (a registered trademark) operating system.

13. A localization method for a printer driver being capable of creating a print setup screen which is displayed on a display section of a computing device and allows a user to set print features thereon, the method comprising:
adding a definition of a dummy feature which do not affect the print features into a configuration file, the configuration file including definitions of the print features;
designating a string managed by a localization resource file in the definition of the dummy feature, the localization resource file including definitions of strings about the print features;
creating print capability information based on the configuration file and the localization resource file, the print capability information including descriptions of setup items of the print features, descriptions of option values which can be set for each of the setup items, and the string designated in the definition of the dummy feature;
on handling a conflict among the setup items of the print features in the print capability information, reflecting the string designated in the definition of the dummy feature on the print capability information; and
creating the print setup screen on which the string is displayed, based on the print capability information on which the string has been reflected.

14. The localization method of claim 13,
wherein the configuration file is a GPD file, and the print capability information is a PrintCapabilities document.

15. The localization method of claim 13,
wherein the definition of the dummy feature includes a property not to display the dummy feature on the print setup screen.

16. The localization method of claim 13,
the printer driver is a version 4 printer driver to be executed on a Windows (a registered trademark) operating system.
